(19) United States
(12) Patent Application Publication
(10) Pub. No.: US 2020/0173361 A1
(43) Pub. Date: Jun. 4, 2020

(54) TURBOCHARGER, METHOD FOR PRODUCING AN ASSEMBLY OF A TURBOCHARGER AND USE

(71) Applicant: MAN Energy Solutions SE, Augsburg (DE)

(72) Inventors: Sven BRANDT, Munchen (DE); Stefan STÖHR, Obersulmetingen (DE); Lutz AURAHS, Langweid (DE); Stefan ROST, Augsburg (DE); Stefan WEIHARD, Augsburg (DE); Santiago UHLENBROCK, Grafenberg (DE); Sebastian SPENGLER, Wehringen (DE)

(21) Appl. No.: 16/700,295

(22) Filed: Dec. 2, 2019

(30) Foreign Application Priority Data
Dec. 4, 2018 (DE) 10 2018 130 772.1

(51) Int. Cl. F02C 6/12; F01D 25/16

(52) U.S. Cl. CPC F02C 6/12; F01D 25/24; F01D 25/16

(57) ABSTRACT

A turbocharger, includes a turbine for expanding a first medium, a compressor for compressing a second medium utilising energy extracted in the turbine during the expansion of the first medium. The turbine housing and a compressor housing are each connected to a bearing housing arranged between the same. The turbine housing, and/or the compressor housing and/or the bearing housing form/s a stator-side assembly and/or receive/s a stator-side assembly, which serves for the lubrication, and/or heat conduction, and/or sealing. The respective stator-side assembly which serves for the lubrication, and/or heat conduction, and/or sealing, is produced by a generative manufacturing method.

### BACKGROUND OF INVENTION

### 1. Field of the Invention

The invention relates to a turbocharger. The invention, furthermore, relates to a method for producing an assembly of a turbocharger and use of the assembly and of the method.

### 2. DESCRIPTION OF RELATED ART

The fundamental construction of a turbocharger is known to the person skilled in the art addressed here. A turbocharger comprises a turbine in which a first medium is expanded. Furthermore, a turbocharger comprises a compressor in which a second medium is compressed utilising the energy extracted in the turbine during the expansion of the first medium. The turbine of the turbocharger comprises a turbine housing and a turbine rotor. The compressor of the turbocharger comprises a compressor housing and a compressor rotor. Between the turbine housing and the compressor housing a bearing housing is positioned, wherein the bearing housing is connected on the one hand to the turbine housing and on the other hand to the compressor housing. In the bearing housing, a shaft is mounted via which the turbine rotor is coupled to the compressor rotor.

Stator-side assemblies of turbochargers have been embodied as cast components to date. In particular when structures that serve for the lubrication, and/or heat conduction, and/or sealing are to be introduced into such a component, the structures have to be either mechanically worked into the blank produced by casting or introduced even during the casting by way of suitable cores in the blank. By way of this, the structures to be introduced are subject to tight limits in terms of manufacturability.

### SUMMARY OF THE INVENTION

One aspect of the invention is based on creating a new type of turbocharger, a method for producing an assembly of a turbocharger, and to create a suitable use of the assembly and of the method.

According to one aspect of the invention, the respective stator-side assembly, which serves for the lubrication, and/or heat conduction, and/or sealing, is produced by a generative manufacturing method preferentially by 3D-printing. With the invention present here it is proposed for the first time to produce a stator-side assembly of a turbocharger, which serves for the lubrication, and/or heat conduction, and/or sealing, by a generative manufacturing method, preferentially by 3D-printing. By way of this, production method-related geometrical restrictions on the component to be produced such as are usual during casting no longer apply. By using a generative manufacturing method for producing a stator-side assembly of a turbocharger, media passages, specific support structures, and/or hollow spaces in particular can be produced with porosities or honeycomb structures which are particularly suitable for the lubrication, and/or heat conduction, and/or sealing.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1 is a schematised cross section through a stator-side assembly of a turbocharger;

FIGS. 2A and 2B are schematised cross section through a stator-side assembly of a turbocharger;

FIG. 3 is a schematised cross section through a stator-side assembly of a turbocharger;

FIG. 4 is a schematised cross section through a stator-side assembly of a turbocharger;

FIG. 5 is a schematised cross section through a stator-side assembly of a turbocharger;

FIG. 6 is a schematised cross section through a stator-side assembly of a turbocharger; and

FIG. 7 is a schematised cross section through a stator-side assembly of a turbocharger.

### DETAILED DESCRIPTION OF THE PRESENTLY PREFERRED EMBODIMENTS

The fundamental construction of a turbocharger is known to the person skilled in the art addressed here. Accordingly, a turbocharger comprises a turbine for expanding a first medium and a compressor for compressing a second medium utilising energy extracted in the turbine during the expansion of the first medium. The first medium to be expanded in the turbine is exhaust gas and the second medium to be compressed in the compressor is charge air of an internal combustion engine.

A turbine comprises a turbine stator and a turbine rotor. The turbine stator includes a turbine housing that can receive other stator-side assemblies of the turbine. A compressor a compressor stator and a compressor rotor. The compressor stator includes a compressor housing that can receive other stator-side assemblies of the compressor.

The turbine rotor, which is also referred to as turbine impeller is connected to the compressor rotor which is also referred to as compressor impeller, by a shaft, wherein the shaft is mounted in a further stator-side component of the turbocharger, namely in a bearing housing. The bearing housing is positioned between the turbine housing and the compressor housing and connected both to the turbine housing and also to the compressor housing.

For the heat conduction, and/or lubrication, and/or sealing a turbocharger comprises stator-side assemblies. Such stator-side assemblies which serve for the lubrication, and/or heat conduction, and/or sealing can be an integral part of the turbine housing, and/or of the compressor housing, and/or of the bearing housing or be received as separate assembly by the turbine housing or compressor housing or bearing housing. Such stator-side assemblies include for example bearing body, bearing bushes, assemblies for the sealing air conduction and the like.

With the invention it is proposed that the respective stator-side assembly, which serves for the lubrication, and/or, heat conduction, and/or sealing, be produced by a generative manufacturing method, in particular by 3D-printing.

Accordingly, with the invention present here a turbocharger having at least one stator-side assembly which serves for the lubrication, and/or heat conduction, and/or sealing is proposed which either is an integral part of the turbine housing, and/or compressor housing, and/or bearing housing of the turbocharger or which is formed as a separate assembly and received by the turbine housing, and/or compressor housing, and/or bearing housing, wherein this stator-side assembly is produced by a generative manufacturing method, preferentially by 3D-printing.

Furthermore, the invention proposes a method for producing such a stator-side assembly of a turbocharger which serves for the lubrication, and/or heat conduction, and/or sealing by a generative manufacturing method, in particular by 3D-printing.

Furthermore, the invention proposes an assembly produced by a generative manufacturing method, in particular by 3D-printing as stator-side assembly of a turbocharger, which serves for the lubrication, and/or heat conduction, and/or sealing.

Finally it is proposed to use a generative manufacturing method, in particular 3D-printing for producing a stator-side assembly of a turbocharger which serves for the lubrication, and/or heat conduction, and/or sealing.

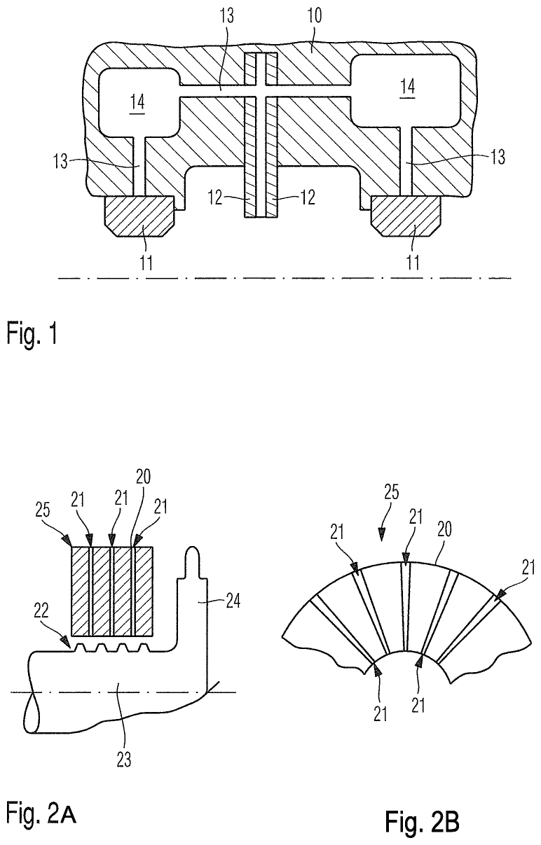

FIG. 1 shows a schematised cross section through an assembly 10 of a turbocharger according to one aspect of the invention, when the assembly 10 is a bearing body. This bearing body 10 is preferentially received by a bearing housing of the turbocharger.

The bearing body 10 shown in FIG. 1 is preferentially formed as a separate assembly, received by the bearing housing of the turbocharger and in the shown exemplary embodiment carries on the one hand radial bearings 11 and on the other hand axial bearings 12 for mounting a shaft of the turbocharger. In the bearing body 10 produced by the generative manufacturing method, oil passages 13 and oil storage spaces 14 are introduced, which serve for conduction of oil that serves for the lubrication and if required cooling of the shaft, which is not shown. Such a bearing body 10 can be particularly advantageously produced by 3D-printing.

FIGS. 2A and 2B show two cross sections through a further stator-side component 20 of a turbocharger, wherein this component 20 is an assembly in which the sealing air passages 21 are introduced. The sealing air passages 21 are offset relative to one another both in the axial direction and also in the circumferential direction, wherein by way of the sealing air passages 21 of the stator-side assembly 20, sealing air can be directed in the direction of a shaft seal 22 of a shaft 23. This shaft 23 is connected to a turbine impeller 24. Such a component 20 can also be utilised for the sealing air conduction in the region of a compressor. The component 20 is preferentially received in a bearing housing or can also be an integral part of a bearing housing 25.

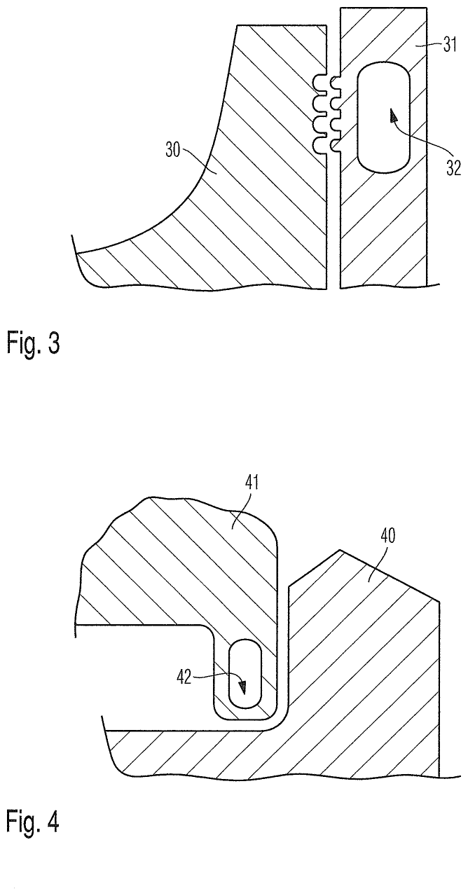

FIG. 3 shows an extract from a turbocharger in the region of a compressor impeller 30 and of a stator-side assembly 31 adjoining the compressor impeller 30, which is an integral part of the compressor housing. In the assembly 31, a hollow structure, namely a hollow space 23 is introduced, which can serve for media conduction to conduct, in particular, a cooling medium through the hollow space 32 for cooling the compressor rotor 30. Here it is possible to either conduct air or oil through the hollow space 32. The hollow space 32 can be embodied without connecting bores or alternatively with connecting bores to the surroundings.

FIG. 4 shows an extract from a turbocharger according to the invention in the region of a turbine, namely in the region of a turbine impeller 40 and of an adjoining turbine housing 41. In the stator-side turbine housing 41 a hollow space 42 is introduced, which serves for cooling, here for the cooling of the turbine rotor 40. As an analogy to the exemplary embodiment of FIG. 3, this hollow space 42 can serve for the media conduction, in particular the conduction of air or oil in order in order to cool the turbine rotor 40. Here, the hollow space 42 can be again embodied with connecting bores or without connecting bores to the surroundings.

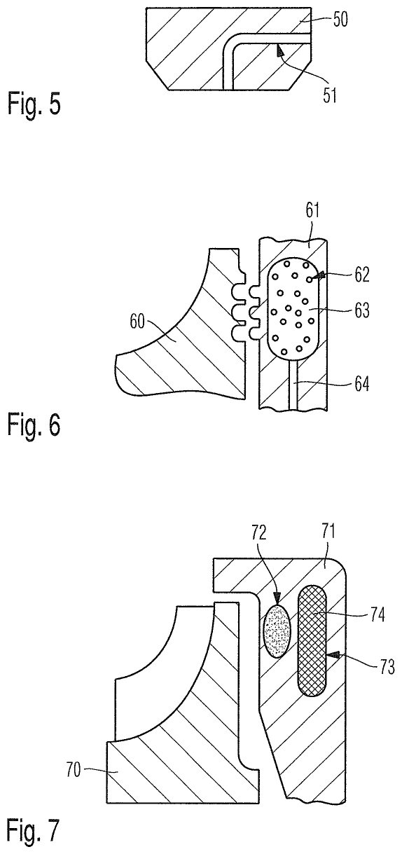

FIG. 5 shows a schematised cross section through a further stator-side component 50 of a turbocharger. The component 50 is a bearing bush. In this bearing bush 50, a media conduction passage 51 is introduced, in particular for conducting oil in the direction of a running surface of a shaft to be mounted. Accordingly, the component 50 serves for mounting and lubricating and, if required, cooling of a shaft of the turbocharger, but the component 50 as such is a stator-side assembly. The bearing bush is preferentially received in the bearing housing of the turbocharger.

A further extract from a turbocharger according to the invention is shown by FIG. 6, namely analogously to FIG. 3, as an extract from a compressor impeller 60 combined with a compressor housing 61. In the compressor housing 61, a hollow space 62 is introduced, namely a hollow space 62 with specific porosities 63. By way of a passage 64, this hollow space 32 can be supplied with coolant in order to cool the compressor impeller 60.

FIG. 7 shows a further extract from a turbocharger according to one aspect of the invention in the region of a compressor impeller 70 and of a compressor housing 71. The compressor housing 71 is again a stator-side assembly. Into this stator-side assembly, two defined structures are introduced in FIG. 7, namely a coolant passage 72 for cooling the compressor impeller 70 and a hollow space 73 with, for example, a honeycomb structure 74, in order to provide a heat-insulating effect. The honeycomb structure 74 can be filled with a gas or heat-insulating materials.

Cooling and heating insulation both serve for a heat conduction, namely the cooling of the discharge of heat from the component to be cooled and the heat insulation of the shielding of a component to be insulated from heat input.

The invention proposes producing a stator-side component of a turbocharger, which serves for the lubrication, and/or heat conduction, and/or sealing, by an additive manufacturing method, preferentially 3D-printing.

This component can be embodied either as a separate component or be an integral part of a compressor housing or turbine housing or bearing housing of the turbocharger.

Structures, such as for example media conduction structures, and/or support structures, or the like can be introduced into the component, namely without geometrical restrictions as is the case during casting. By way of this it is possible to conduct a medium for the cooling, and/or lubrication, and/or sealing via complex geometrical structures in order to ensure an optimal lubrication, and/or cooling, and/or sealing.

The assemblies, relating to the invention, are metallic assemblies, wherein for the printing of such metallic assemblies metal powders are provided which are then applied onto one another or melted onto one another in layers by 3D-printing for producing the component.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A turbocharger, comprising:
a turbine for expanding a first medium,
a compressor for compressing a second medium utilizing energy extracted in the turbine during expansion of the first medium,
a turbine housing of the turbine;
a compressor housing of the compressor;
a bearing housing arranged between and connected to the compressor housing and the turbine housing;
wherein at least one of the turbine housing, the compressor housing, and the bearing housing forms a stator-side assembly and/or receives the stator-side assembly, which serves for at least one of lubrication, heat conduction, and sealing,
wherein a respective stator-side assembly that serves for the at least one of the lubrication, the heat conduction, and the sealing is produced by a generative manufacturing method.

2. The turbocharger according to claim 1, wherein the respective stator-side assembly that serves for the at least one of the lubrication, the heat conduction, and the sealing is produced by 3D-printing.

3. The turbocharger according to claim 1, wherein the respective stator-side assembly is a bearing body with oil conduction passages.

4. The turbocharger according to claim 1, wherein the respective stator-side assembly comprises sealing air passages configured to conduct sealing air in a direction of a shaft seal.

5. The turbocharger according to claim 1, wherein the respective stator-side assembly comprises hollow spaces for the heat conduction of a turbine impeller of one of the turbine and a compressor impeller of the compressor.

6. A method for producing a stator-side assembly of a turbocharger, configured for at least one of lubrication, heat conduction, and sealing, comprising:
Producing the the stator-side assembly by a generative manufacturing method.

7. The method according to claim 6, wherein the stator-side assembly is produced by 3D-printing.
